(19) United States
(12) Patent Application Publication
(10) Pub. No.: US 2011/0006124 A1
(43) Pub. Date: Jan. 13, 2011

(54) TEMPERATURE CONTROL METHOD, TEMPERATURE CONTROL APPARATUS, AND OPTICAL DEVICE

(75) Inventor: Yutaka KAI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/833,200

(22) Filed: Jul. 9, 2010

(30) Foreign Application Priority Data
Jul. 10, 2009 (JP) 2009-163663

(51) Int. Cl. G05D 23/00

(52) U.S. Cl. 236/46 R

(57) ABSTRACT

A temperature control apparatus controlling the temperature of an optical element that is driven in response to a drive current that is applied, the temperature control apparatus including: a temperature controller that changes the temperature of the optical element; and a controller that controls current to the temperature controller, wherein the controller determines a time from when an amount of heat from the temperature controller has been generated by the current control until the amount of heat reaches the optical element and controls the current to the temperature controller the determined time before the drive current is applied to the optical element.

### CROSS REFERENCE TO RELATED APPLICATION

This application is based upon and claims the benefit of priority of the prior Japanese Patent Application No. 2009-163663, filed on Jul. 10, 2009, the entire contents of which are incorporated herein by reference.

### FIELD

The embodiments relate to a temperature control method, a temperature control apparatus, and an optical device. The temperature control includes, for example, temperature control of a semiconductor optical element.

### BACKGROUND

Semiconductor lasers including tunable laser diodes (LDs) and semiconductor optical elements including semiconductor optical amplifiers (SOAs) and photodetectors (PDs) exhibit various optical characteristics in response to control of voltage that is applied.

However, upon application of voltage to semiconductor optical elements (hereinafter also simply referred to as “optical elements”) to drive the optical elements, the active layer parts of the optical elements are increased in temperature due to self-heating of the optical elements. As a result, the band gap energies of the semiconductors forming the active layer parts may be varied to vary the optical characteristics of the optical elements.

Accordingly, in control of voltage that is applied to drive the optical elements, for example, temperature control devices that control the optical elements so as to have constant temperature values may be used along with the optical elements in order to achieve desired optical characteristics. Specifically, for example, temperature detection devices such as platinum temperature measuring resistors, thermocouples, or thermistors detect the temperatures of the optical elements and the temperature control devices such as Peltier elements or heaters perform feedback temperature control based on the result of the detection to control the optical elements so as to have constant temperature values.

Technologies in related art include a laser-diode drive circuit provided with a feed-forward automatic power control (APC) circuit that compensates a variation in the optical output peak power due to a variation in the mark ratio (Japanese Laid-open Patent Publication No. 2002-237649).

In addition, a method is disclosed in which a temperature controller is simply and instantaneously switched to an output-wavelength controller in drive of a wavelength-locked LD with the output wavelength set at a constant value while performing feedback compensation of the heating-cooling effect of a thermoelectric cooling (TEC) element in the wavelength-locked LD to effectively suppress an occurrence of discontinuity in the control (Japanese Laid-open Patent Publication No. 2003-198054).

Furthermore, a method of controlling the amplification gain of an optical signal, which includes both electrical feedforward and electrical feedback, is disclosed (Japanese Laid-open Patent Publication No. 2003-283027).

However, with the temperature control methods described above, the temperature detection device detects a change in temperature of an optical element and the temperature control device performs the feedback temperature control based on the result of the detection. Accordingly, it takes a long time to enable the temperature control after the temperature of the optical device is varied.

Since the temperature detection device is generally arranged near the optical element, it takes a certain time to detect the variation in temperature by the temperature detection device since the temperature of the optical element has been actually varied.

Accordingly, in the feedback control of the temperature of the optical element, it is difficult to control the temperature of the optical element on the order of seconds or less because it takes a longer time to enable the temperature control since the temperature of the optical element has been varied.

FIG. 1 illustrates an example of how output voltages of an optical element are varied with time when the feedback temperature control (for example, Proportional-Integral-Derivative (PID) control) is performed in order to make the output of the optical element, to which a drive voltage is applied, constant. In the example in FIG. 1, an SOA is used as the optical element and an optical signal having a wavelength of 1,552.5 nm and a power of −15 dBm is used as an input signal into the SOA. Referring to FIG. 1, the vertical axis represents the output voltage (optical output power) of the SOA and the horizontal axis (logarithmic axis) represents time.

When a drive current (for example, a pulse current) of 300 mA is applied to the SOA in an OFF state (the drive current=0 mA) as in the example in FIG. 1, the optical output power of the SOA is decreased until about one second elapsed since the application of the drive current. This is because the self-heating occurs in the SOA in response to the application of the drive current and the amplification efficiency of the SOA is reduced due to the variation in temperature. In the example in FIG. 1, the optical output power of the SOA attenuates by about 3.5 dB for about one second since the application of the drive current.

After about one second since the drive current has been applied to the SOA, for example, a temperature detection device (temperature sensor) provided near the SOA detects a change in temperature in the SOA and a temperature control device, such as a Peltier element, starts to cool the SOA based on the result of the detection.

However, as described above, it takes about one second for the change in temperature of the SOA to reach the temperature detection device and it takes a certain time for the cooling heat from the temperature control device to reach the SOA. As a result, for example, in application of a drive current of 300 mA, it takes about 100 seconds to cause the optical output power of the SOA to stabilize (converge) since the application of the drive current.

Also in application of drive currents of 200 mA, 150 mA, and 100 mA, the optical output power of the SOA attenuates by about 2.6 dB, 2.4 dB, and 2.6 dB, respectively, for about one second since the application of the drive current. In addition, it takes about 30 seconds to cause the output from the SOA to stabilize since the application of the drive current in either case.

A method of increasing the amount of drive current to be applied to the optical element may be adopted in order to compensate the attenuation of the optical output power of the optical element. However, since the amount of self-heating of the SOA is increased with the increasing amount of drive current in this case, the optical output power is further reduced. Accordingly, the method of controlling the amount of drive current to control the optical element so as to have a constant output level is not effective.

Since optical elements using compound semiconductor generally have resistive components, the optical elements generate heat in response to application of drive currents and the output characteristics of the optical elements are varied.

Accordingly, in current control of the optical elements at higher speed, the feedback temperature control may not follow variations in the output characteristics of the optical elements. In addition, there are cases in which the thermal states of the optical elements are varied depending on the temperature state around the optical elements and, thus, the feedback control may not rapidly respond to the variation in temperature.

### SUMMARY

According to an aspect of one embodiment, a temperature control apparatus controlling the temperature of an optical element that is driven in response to a drive current that is applied, the temperature control apparatus including: a temperature controller that changes the temperature of the optical element; and a controller that controls current to the temperature controller, wherein the controller determines a time from when an amount of heat from the temperature controller has been generated by the current control until the amount of heat reaches the optical element and controls the current to the temperature controller the determined time before the time when the drive current is applied to the optical element.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of how output voltages of an optical element are varied with time;

FIG. 2 illustrates an example of the configuration of an optical module;

FIG. 3 illustrates examples of the time response waveforms of parameters in the optical module;

FIG. 4 illustrates examples of the time response waveforms of parameters in the optical module;

FIG. 5 illustrates examples of the time response waveforms of parameters in the optical module;

FIG. 6 illustrates an example of the configuration of an optical device according to an embodiment;

FIG. 7 illustrates examples of the time response waveforms of parameters in the optical device;

FIG. 8A illustrates an example of how a chip temperature is varied with time in feedback temperature control;

FIG. 8B illustrates an example of how the chip temperature is varied with time in feedforward temperature control;

FIG. 9 illustrates an example of the arrangement of the optical module;

FIG. 10 illustrates an example of the configuration of the optical module;

FIG. 11 illustrates an example of the configuration of a Peltier TEC and parameters;

FIG. 12 illustrates an example of the relationship of input and output of heat in the optical module;

FIG. 13 illustrates an example of the relationship between a drive current I_{drive} and a Peltier current I_{TEC};

FIG. 14 illustrates examples of amounts of Peltier current in a sequence I in FIG. 13;

FIG. 15 illustrates examples of amounts of Peltier current in a sequence II in FIG. 13; and

FIG. 16 illustrates an example of the configuration of an optical device according to a first modification.

### DESCRIPTION OF EMBODIMENTS

Embodiments of the present invention will herein be described with reference to the attached drawings. However, the embodiments described below are only examples and it will be clear that this invention is not limited to these specific examples and embodiments and that many changes and modified embodiments will be obvious to those skilled in the art, based on the present disclosure, without departing from the true spirit and scope of the invention.

### [1] Embodiments

(1.1) Configuration of Optical Module

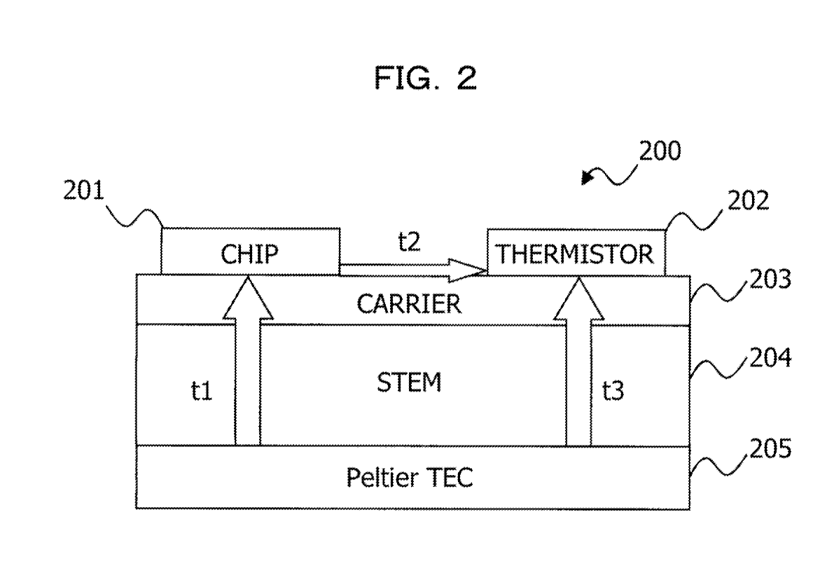

FIG. 2 illustrates an example of the configuration of an optical module. Referring to FIG. 2, an optical module 200 includes, for example, an optical element (chip) 201, a thermistor 202, a carrier 203, a stem 204, and a temperature controller (Peltier thermoelectric cooler (TEC)) 205.

The chip 201 exhibits a certain optical function in response to a drive current that is applied. Various optical function devices including a tunable LD whose wavelength is controlled in response to an electric current, a semiconductor LD having a pulse-shaped output, an SOA, and a PD are applicable to the chip 201.

The thermistor 202 detects the temperature of the chip 201 (hereinafter also referred to as a chip temperature). For example, various thermistors including a Negative Temperature Coefficient (NTC) thermistor, a Positive Temperature Coefficient (PTC) thermistor, and a Critical Temperature Resistor (CTR) thermistor are applicable to the thermistor 202. Instead of the thermistor 202, a platinum temperature measuring resistor or a thermocouple may be used. Although the thermistor 202 practically detects the heat (a variation in temperature) transmitted from the chip 201 through the carrier 203 because the thermistor 202 is provided, for example, near the chip 201, the thermistor 202 may approximately measure the chip temperature based on the result of the detection.

The carrier 203 has the chip 201 and the thermistor 202 mounted thereon. The carrier 203 may be formed of, for example, a metal plate member. The stem 204 has the carrier 203 mounted thereon. The stem 204 may be formed of, for example, a metal member.

The Peltier TEC 205 changes the temperature of the chip 201. For example, the Peltier TEC 205 generates cooling heat corresponding to a current (hereinafter referred to as a Peltier current) that is applied. The Peltier TEC 205 may be, for example, bias driven to cool or heat a target. Instead of the Peltier TEC 205, another temperature control device, such as a heater or a water cooling device, may be used. The heater is a temperature control device that generates heat corresponding to the drive current. The water cooling device, for example, controls the flow rate of the cooling water in accordance with the amount of drive current to perform the temperature control.

In the optical module 200 illustrate in FIG. 2, for example, the stem 204 is mounted on the Peltier TEC 205, and the carrier 203 on which the chip 201 and the thermistor 202 are mounted is arranged on the stem 204.

The carrier 203 is normally arranged apart from the stem 204 in consideration of, for example, the yield, the cost, and/or the evaluation process of the chip 201. Specifically, this is because an optical part such as a lens is generally mounted on the stem 204 and, if the evaluation indicates that the chip 201 does not have a sufficient quality after the carrier 203 on which the chip 201 is mounted and the stem 204 are integrally manufactured, it is desirable to replace all of the carrier 203, the chip 201, and the stem 204, thus requiring a higher cost.

In addition, since the chip 201 is smaller than other members (for example, the thermistor 202 and the lens), it is not possible to evaluate the chip 201 by itself. Accordingly, the chip 201 is normally bonded to the carrier 203 and is electrified and evaluated by using the pattern on the carrier 203. The chip 201 that has passed the evaluation is mounted on the stem 204. However, the chip 201 may be damaged because heat is applied in the bonding. Consequently, it is more efficient to evaluate the chip 201 bonded to the carrier 203 and to mount the carrier 203 on the stem 204 provided separately from the carrier 203.

The chip 201 and the thermistor 202 may be arranged on the carrier 203 with a certain distance provided therebetween. Upon start of the self heating of the chip 201 in response to the drive current that is applied, the heat generated in the chip 201 is first transmitted to the carrier 203.

The heat generated in the chip 201 reaches the thermistor 202, for example, after a thermal time constant t2 (t2>0) elapsed and a variation in temperature of the chip 201 is detected (measured) in the thermistor 202. The thermal time constant t2 represents a time required to transmit the amount of heat from the chip 201 to the thermistor 202 through the carrier 203. Accordingly, the thermal time constant t2 is varied depending on, for example, the material of the carrier 203 and/or the distance between the chip 201 and the thermistor 202.

In feedback control of the chip temperature in the optical module 200, for example, the thermistor 202 detects heat after the thermal time constant t2 elapsed since the generation of the heat in the chip 201 and the Peltier TEC 205 controls the chip temperature based on the result of the detection.

As described above, the thermal time constant t2 is one factor to increase a convergence time (a time required to make the temperature of the chip 201 constant) in the feedback control of the chip temperature.

The heat (for example, the cooling heat) generated in the Peltier TEC 205 is transmitted to the chip 201 and the thermistor 202 through the stem 204 and the carrier 203.

The heat generated in the Peltier TEC 205 reaches the chip 201, for example, after a thermal time constant t1 (t1>0) elapsed since the generation of the heat in the Peltier TEC 205 and reaches the thermistor 202 after a thermal time constant t3 (t3>0) elapsed since the generation of the heat in the Peltier TEC 205. The thermal time constant t1 represents a time required to transmit the amount of heat from the Peltier TEC 205 to the chip 201 through the stem 204 and the carrier 203. The thermal time constant t3 represents a time required to transmit the amount of heat from the Peltier TEC 205 to the thermistor 202 through the stem 204 and the carrier 203. Accordingly, the values of the thermal time constants t1 and t3 are varied depending on, for example, the materials of the stem 204 and the carrier 203 and/or the material widths of the carrier 203 and the stem 204.

In the feedback control of the chip temperature in the optical module 200, for example, the thermistor 202 detects heat after the thermal time constant t2 elapsed since the generation of the heat in the chip 201 and the Peltier TEC 205 performs the feedback control of the chip temperature based on the result of the detection.

In the feedback control, the cooling heat generated in the Peltier TEC 205 reaches the chip 201 after the thermal time constant t1 elapsed and reaches the thermistor 202 after the thermal time constant t3 elapsed.

As described above, each of the thermal time constant t1 and the thermal time constant t3 is one factor to increase the convergence time in the feedback control of the chip temperature. In the configuration of the optical module 200 in FIG. 2, the thermal time constant t1 has approximately the same value as that of the thermal time constant t3 because of the distance between the Peltier TEC 205 and the chip 201, the distance between the Peltier TEC 205 and the thermistor 202, and/or the characteristics of the material provided between the Peltier TEC 205 and the chip 201 and the thermistor 202.

(1.2) Time Response Characteristics of Optical Module 200

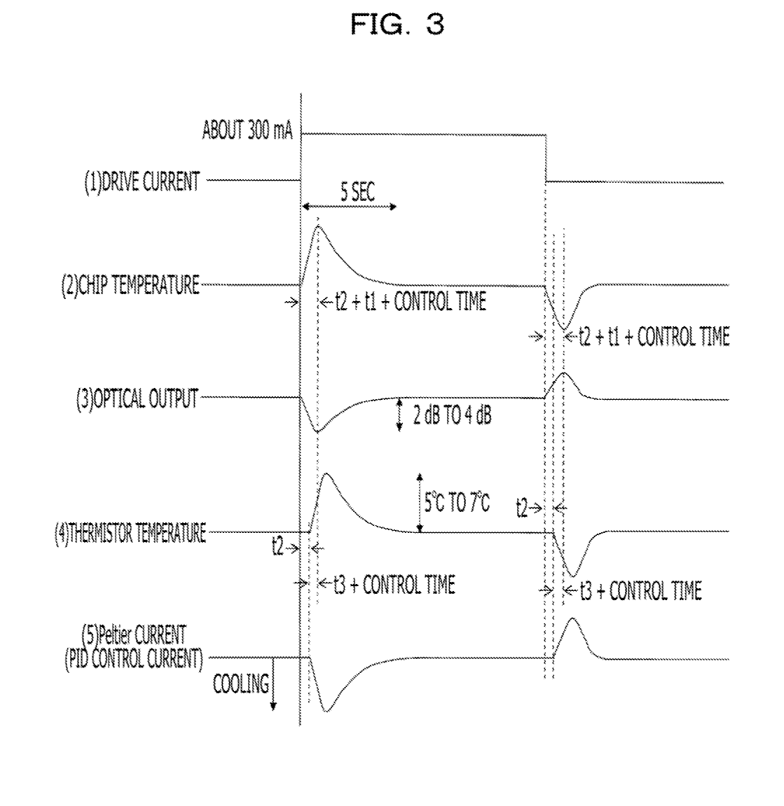

FIG. 3 illustrates examples of the time response waveforms of parameters in the optical module 200 when, for example, a pulse-shaped drive current of about 300 mA is applied to the chip 201 in the optical module 200.

Referring to FIG. 3, in response to application of the drive current to the chip 201 (refer to (1) Drive current in FIG. 3), the chip temperature increases (refer to (2) Chip temperature in FIG. 3).

The chip temperature is estimated from, for example, a temperature (hereinafter also referred to as a thermistor temperature) detected by the thermistor 202, as described above.

The thermistor 202 detects the heat generated in the chip 201 after the thermal time constant t2 elapsed since the increase in the chip temperature (refer to (4) Thermistor temperature in FIG. 3).

Upon detection of the increase in the chip temperature by the thermistor 202, the Peltier TEC 205 starts to cool the chip 201 by the feedback temperature control (PID control) (refer to (5) Peltier current in FIG. 3).

The optical output from the chip 201 continues to decrease during a time “t2+t1(≈t3)+control time” due to the increase in the chip temperature (refer to (3) Optical output in FIG. 3). The control time indicates a time since the thermistor temperature has decreased until the Peltier TEC 205 generates the cooling heat.

When the cooling heat from the Peltier TEC 205 reaches the chip 201, the chip temperature starts to decrease and the optical output starts to increase.

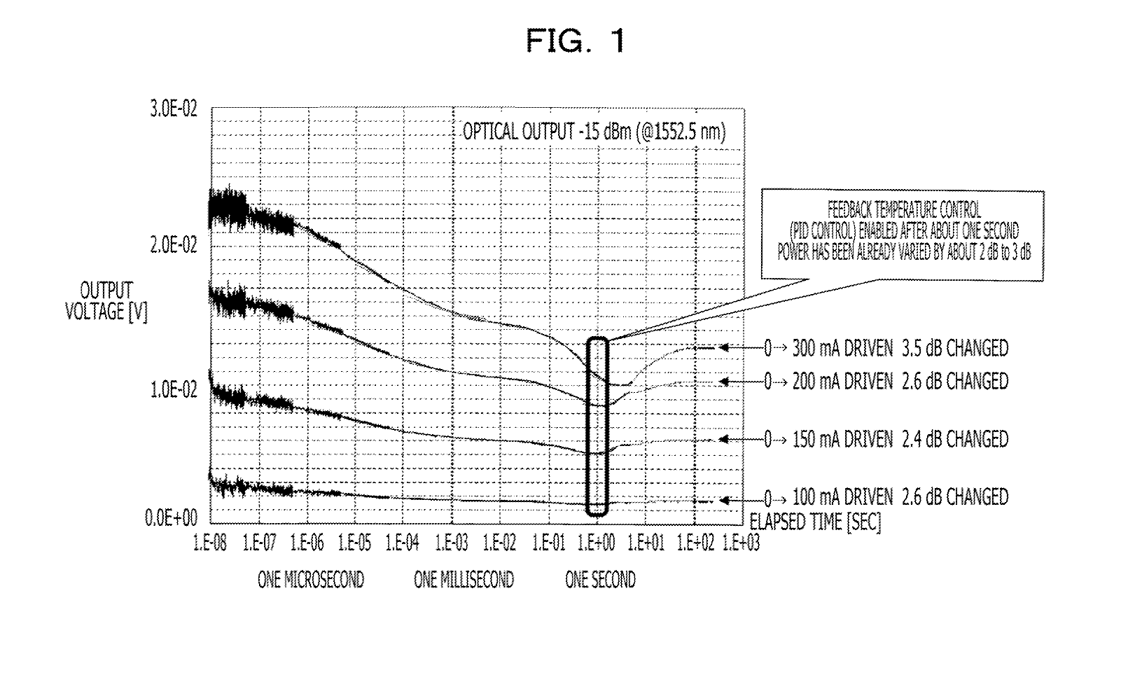

In the feedback temperature control by using the common optical module 200 and the temperature control devices (for example, the thermistor 202 and the Peltier TEC 205), “t2+t1(≈t3)+control time” is equal to about one second, as described above with reference to FIG. 1.

In the example in FIG. 3, the chip temperature increases by about 5° C. to 7° C. and the optical output decreases by about 2 dB to 4 dB in response to the application of the drive current. In addition, it takes around five seconds for the chip temperature to return to the original temperature since the application of the drive current to the chip 201.

Upon stop of the application of the drive current, the chip temperature decreases because the cooling heat from the Peltier TEC 205 is supplied for a certain time although the increase in the chip temperature due to the self heating is stopped. Accordingly, the optical output temporarily increases. This is because the thermistor 202 detects the change in temperature after the thermal time constant t2 elapsed since the increase in the chip temperature was stopped and, thus, the temperature control by the Peltier TEC 205 lags by the thermal time constant t2. The temporal increase in the optical output continues for the time “t2+t1(≈t3)+control time” since the application of the drive current has stopped.

In this case, the thermistor 202 detects the decrease in the chip temperature after the thermal time constant t2 elapsed since the decrease in the chip temperature and the Peltier TEC 205 starts to heat the chip 201 based on the result of the detection. However, since the thermistor 202 detects the chip temperature after the thermal time constant t2 elapsed since the chip temperature was actually changed, over-heating and over-cooling are repeated.

Subsequently, the cooling and the heating of the chip 201 are repeated by the Peltier TEC 205 and the chip temperature converges into a substantial constant value. The convergence time is varied depending on the amount of drive current, as described above with reference to FIG. 1.

As described above, in the feedback control of the chip temperature in the optical module 200, the time required for the control is increased because of, for example, the thermal time constants t1 to t3 described above. As a result, the time required to make the optical output from the chip 201 substantially constant (to stabilize the optical output from the chip 201) is increased.

In order to resolve this problem, the Peltier current is controlled prior to the application of the drive current in the present embodiment. For example, the optical module 200 of the present embodiment calculates the thermal time constant t1 in advance and controls the Peltier current the thermal time constant t1 before the application of the drive current to substantially concurrently advance the increase in temperature due to the self heating of the chip 201 and the cooling of the chip 201 by the Peltier TEC 205.

As a result, since the variation in the chip temperature is suppressed, it is possible to perform the temperature control more rapidly. In addition, the calculation of the thermal time constant t2 and t3 allows, for example, the efficiency of the feedback temperature control to be further improved. A method of calculating the thermal time constants t1 to t3 will now be described.

(1.3) Method of Calculating t1 to t3

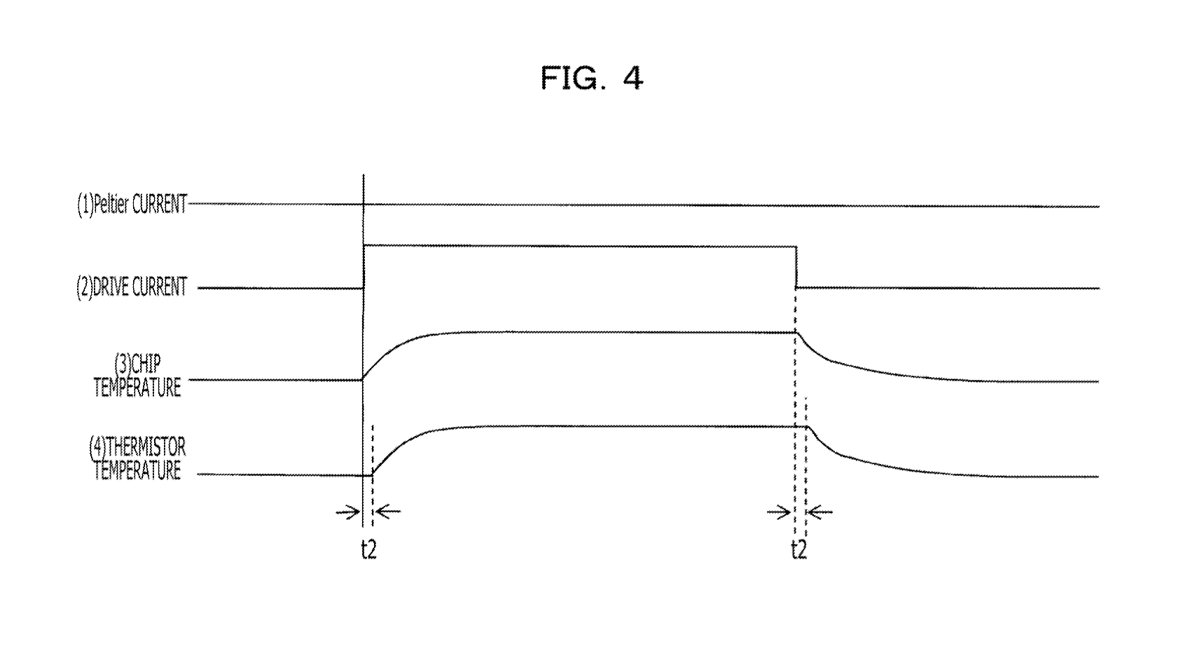

A method of calculating the thermal time constant t2 will now be described with reference to FIG. 4. FIG. 4 illustrates examples of the time response waveforms of parameters in the optical module 200 when the Peltier current is made constant.

As illustrated in FIG. 4, in the calculation of the thermal time constant t2, for example, a constant Peltier current is applied to the Peltier TEC 205 (refer to (1) Peltier current in FIG. 4) and a pulse-shaped drive current is applied to the chip 201 (refer to (2) Drive current in FIG. 4).

In response to the application of the drive current, the self heating occurs in the chip 201 and the chip temperature stats to increase (refer to (3) Chip temperature in FIG. 4), as described above. The thermistor 202 detects the increase in the chip temperature after the thermal time constant t2 elapsed since the self heating of the chip 201 (refer to (4) Thermistor temperature in FIG. 4). Accordingly, for example, a current controller 106 described below measures the time since the drive current has been applied until the thermistor 202 detects the change in the temperature in the above operating environment to determine the thermal time constant t2.

Upon stop of the application of the drive current, the thermistor temperature starts to decrease after the thermal time constant t2 elapsed since the application of the drive current was actually stopped (the thermistor 202 detects a decrease in the chip temperature). Accordingly, for example, the current controller 106 described below may measure the time since the application of the drive current has been stopped until the thermistor 202 detects the change in the temperature in the above operating environment to determine the thermal time constant t2.

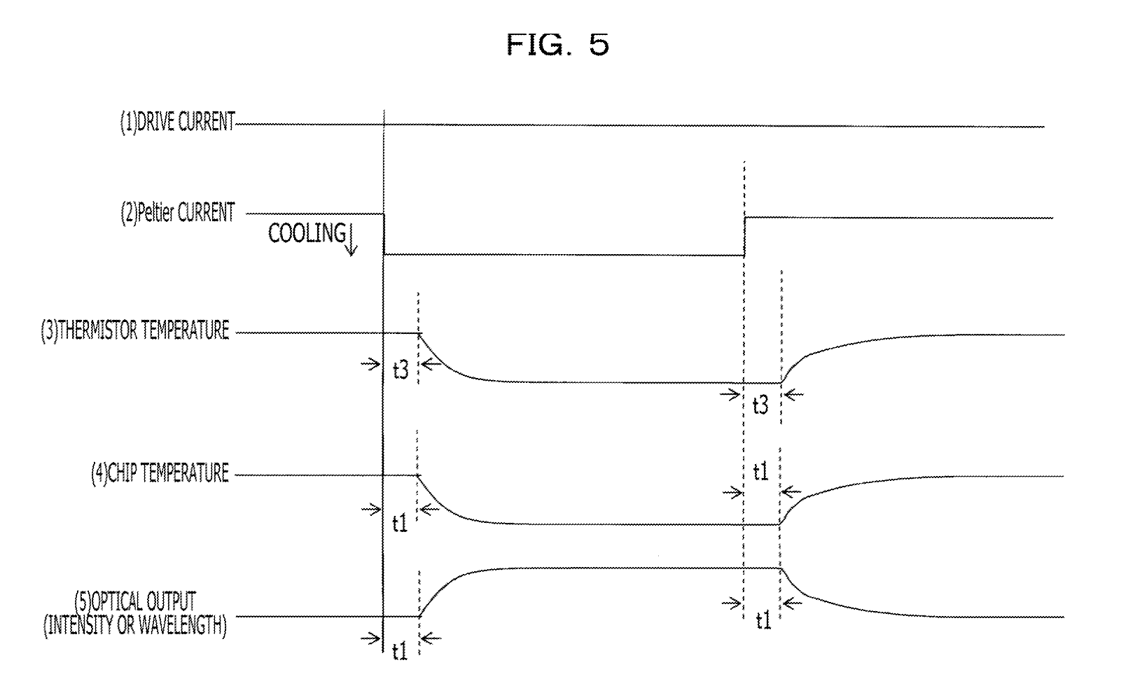

A method of calculating the thermal time constants t1 and t3 will now be described with reference to FIG. 5. FIG. 5 illustrates examples of the time response waveforms of parameters in the optical module 200 when the drive current is made constant.

As illustrated in FIG. 5, in the calculation of the thermal time constants t1 and t3, for example, a substantially-constant drive current is applied to the chip 201 (refer to (1) Drive current in FIG. 5) and a pulse-shaped Peltier current is applied to the Peltier TEC 205 (refer to (2) Peltier current in FIG. 5).

Although the Peltier current (at the cooling side) to cause the Peltier TEC 205 to generate the cooling heat is applied in the example in FIG. 5, a Peltier current (at the heating side) to heat the Peltier TEC 205 may be applied.

Upon application of the Peltier current, as described above, the heat generated in the Peltier TEC 205 reaches the chip 201 after the thermal time constant t1 elapsed since the generation of the heat and reaches the thermistor 202 after the thermal time constant t3 elapsed since the generation of the heat.

In response to the cooling heat from the Peltier TEC 205, the chip temperature starts to decrease after the thermal time constant t1 elapsed since the application of the Peltier current (refer to (4) Chip temperature in FIG. 5) and the optical output (strength or wavelength) starts to increase with the decrease in the chip temperature (refer to (5) Optical output in FIG. 5).

In addition, in response to the cooling heat from the Peltier TEC 205, the thermistor temperature starts to decrease after the thermal time constant t3 elapsed since the application of the Peltier current (refer to (3) Thermistor temperature in FIG. 5). Since the thermal time constant t1 is substantially equal to the thermal time constant t3 in the configuration of the optical module 200 in FIG. 2, the thermistor temperature starts to decrease substantially concurrently with the start of the decrease in the chip temperature, as illustrated in the example in FIG. 5.

Accordingly, for example, the current controller 106 described below measures the time since the Peltier current has been applied until the optical output starts to increase in the above operating environment to determine the thermal time constant t1.

Similarly, for example, the current controller 106 described below measures the time since the Peltier current has been applied until the thermistor temperature starts to decrease in the above operating environment to determine the thermal time constant t3.

Upon stop of the application of the Peltier current, the chip temperature starts to increase after the thermal time constant t1 elapsed since the application of the Peltier current was stopped and the thermistor temperature starts to increase after the thermal time constant t3 elapsed since the application of the Peltier current was stopped. Accordingly, for example, the current controller 106 described below may measure the time since the application of the Peltier current has been stopped until the chip temperature is changed in the above operating environment to determine the thermal time constant t1, and may measure the time since the application of the Peltier current has been stopped until the thermistor temperature is changed in the above operating environment to determine the thermal time constant t3.

The configuration of an optical device according to an embodiment will now be described.

(1.4) Configuration of Optical Device

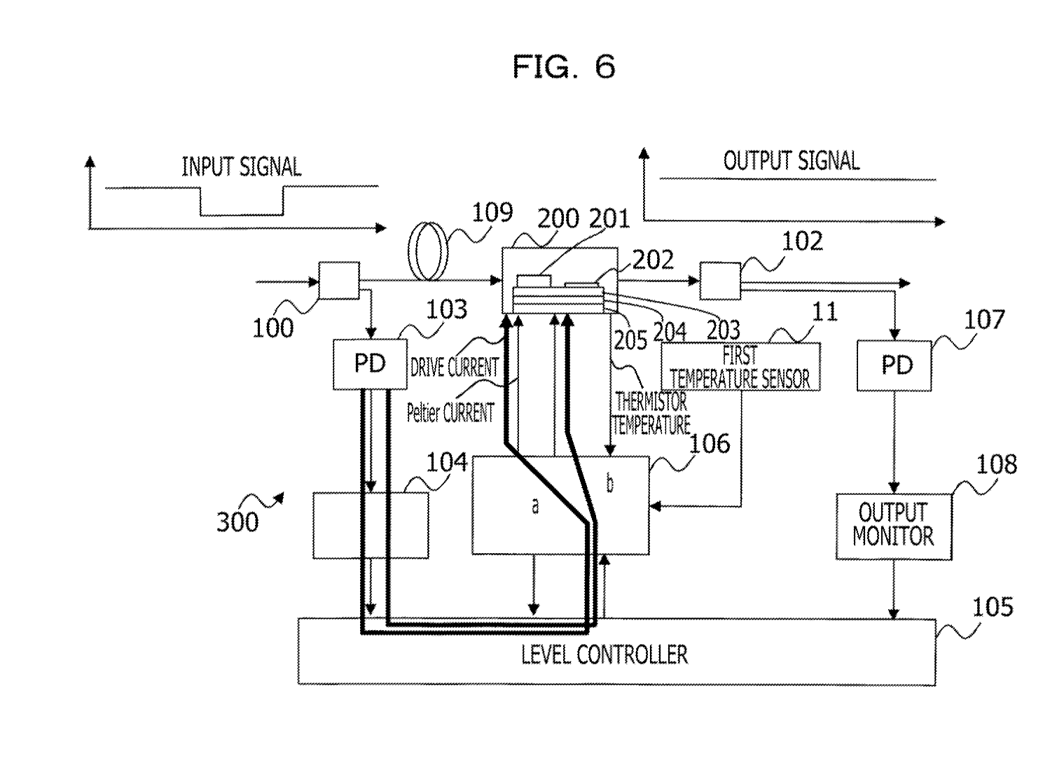

FIG. 6 illustrates an example of the configuration of an optical device according to an embodiment.

Referring to FIG. 6, an optical device 300 includes, for example, a splitter 100, an optical module 200, a splitter 102, a PD 103, an input monitor 104, a level controller 105, and the current controller 106. In addition, the optical device 300 includes, for example, a PD 107, an output monitor 108, a delayer 109, and a temperature sensor (a first temperature sensor) 11.

The splitter 100 splits an input signal (optical signal). The input signal split by the splitter 100 is supplied to the PD 103 and the delayer 109.

The PD 103 converts the received optical signal into an electrical signal. The PD 103 of the present embodiment converts the input signal split by the splitter 100 into an electrical signal and supplies the electrical signal to the input monitor 104.

The input monitor 104 monitors the strength of the received electrical signal. The input monitor 104 of the present embodiment monitors the strength of the electrical signal supplied from the PD 103 and supplies the result of the monitoring to the level controller 105.

The delayer 109 gives a certain delay to the received optical signal. The delayer 109 of the present embodiment gives, for example, at least a delay corresponding to the thermal time constant t1 to the input signal.

The optical module 200 performs, for example, certain optical processing to the input signal. Accordingly, the optical module 200 includes, for example, the chip 201, the thermistor 202, the carrier 203, the stem 204, and the Peltier TEC 205. The chip 201, the thermistor 202, the carrier 203, the stem 204, and the Peltier TEC 205 operate in substantially the same manner as the one described above with reference to FIG. 2.

For example, when the chip 201 is an SOA, the optical module 200 may amplify or attenuate the input signal. Specifically, the optical module 200 amplifies or attenuates the input signal in accordance with the variation in the input signal in order to output an optical signal of a substantially constant output level. The amplification control (or attenuation control) is realized by controlling the drive current by the current controller 106.

The temperature sensor (first temperature sensor) 11 measures the temperature around the chip 201 (hereinafter also referred to as an environmental temperature or ambient temperature). The result of the measurement in the temperature sensor 11 is supplied to the current controller 106. The temperature sensor 11 is desirably provided apart from the optical module 200 by about a few centimeters so as not to be affected by the heat generated by the optical module 200 and so as to monitor the ambient temperature of the chip 201 as correct as possible.

The splitter 102 splits an output signal (optical signal). The splitter 102 of the present embodiment splits an output signal from the optical module 200 into a signal component to be supplied to the PD 107 and a signal component in the direction of an output path.

The PD 107 converts the received optical signal into an electrical signal. The PD 107 of the present embodiment converts the output signal split by the splitter 102 into an electrical signal and supplies the electrical signal to the output monitor 108.

The output monitor 108 monitors the strength of the received electrical signal. The output monitor 108 of the present embodiment monitors the strength of the electrical signal supplied from the PD 107 and supplies the result of the monitoring to the level controller 105.

The level controller 105 controls the current controller 106 based on variations in power (level) of the input signal and the output signal. The control is performed, for example, in response to a control signal supplied from the level controller 105 to the current controller 106. The control signal may include information about the level of the input signal and the input timing of the input signal.

The current controller (controller) 106 performs current control to the Peltier TEC 205. For example, the current controller 106 controls the drive current and the Peltier current based on, for example, the control signal from the level controller 105, the variation in temperature of the chip 201 detected by the thermistor 202, the result of the measurement of the ambient temperature by the temperature sensor 11. The drive current from the current controller 106 is supplied to the chip 201 and the Peltier current from the current controller 106 is supplied to the Peltier TEC 205.

The current controller 106 of the present embodiment, for example, determines the time (t1) since the heat has been generated in the Peltier TEC 205 until the heat reaches the chip 201 and performs the current control to the Peltier TEC 205 the thermal time constant t1 before the application of the drive current to the chip 201. Specifically, the current controller 106 of the present embodiment supplies the Peltier current corresponding to the variation in the chip temperature detected by the thermistor 202 to the Peltier TEC 205 prior to the input signal to which the delay t1 is given by the delayer 109. The current controller 106 performs feedforward temperature control to the chip 201 in the above manner.

In the present embodiment, for example, the provision of the delayer 109 in the optical device 300 causes time allowance before the input signal is input into the optical module 200. Accordingly, the level controller 105 and the current controller 106 are capable of detecting information about the variation in power of the input signal and controlling the Peltier current prior to the variation in the input signal and the drive current based on the result of the detection.

In other words, the current controller 106 is capable of supplying the drive current to the chip 201 in synchronization with the input signal (refer to reference letter a in FIG. 6) and supplying the Peltier current to the Peltier TEC 205 a certain time (for example, t1) before the application of the input signal and the drive current (refer to reference letter b in FIG. 6).

The Peltier TEC 205 and the current controller 106 function as examples of the temperature control devices.

Consequently, since the cooling by the Peltier TEC 205 is started in advance even if the drive current is varied with the variation in the input signal and the chip temperature starts to change in accordance with the variation in the drive current, it is possible to efficiently suppress the variation in the chip temperature. As a result, it is possible to reduce the convergence time of the chip temperature to increase the speed of the temperature control of the chip 201.

When information about the input signal (for example, information about the variation in power of the input signal and the input timing of the input signal) is known (for example, such information is indicated to the current controller 106 in advance), the delayer 109 may be removed from the configuration in FIG. 6 because the Peltier current is controlled prior to the variation in the input signal even if no delay is given to the input signal.

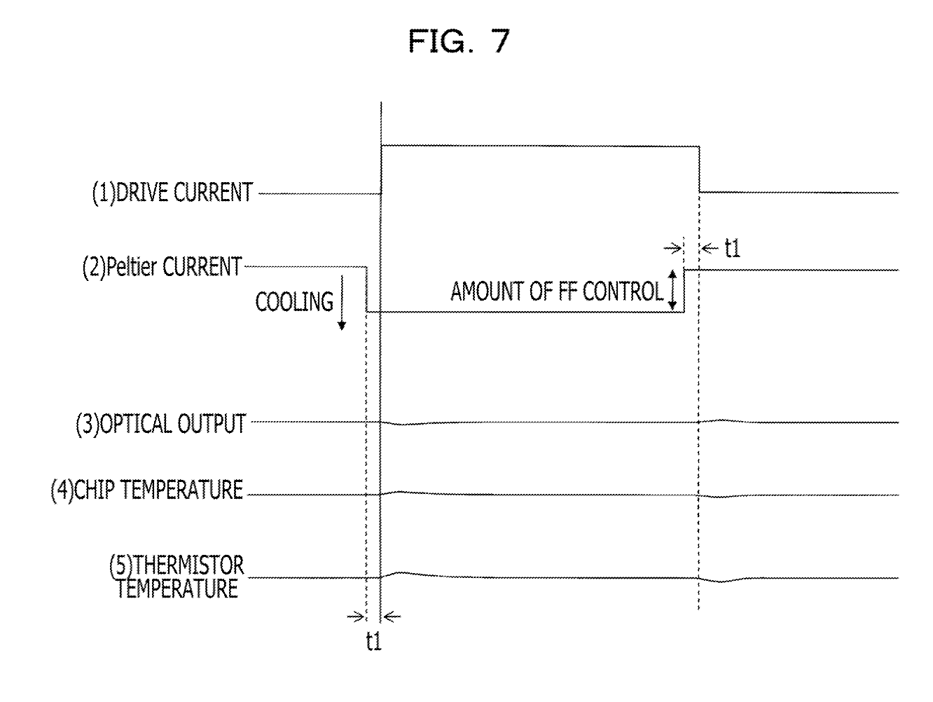

FIG. 7 illustrates examples of the time response waveforms of parameters in the optical device 300.

The current controller 106 of the present embodiment, for example, first calculates the amount of Peltier current (the amount of feedforward (FF) control) in the feedforward temperature control from information about the input signal (or the drive current). How to calculate the amount of FF control will be described below in (1.5).

As illustrated in FIG. 7, the current controller 106 applies the Peltier current corresponding to the amount of FF control to the Peltier TEC 205 the thermal time constant t1 before the application of the drive current to the chip 201 (refer to (2) Peltier current in FIG. 7).

After the thermal time constant t1 elapsed since the application of the Peltier current, the current controller 106 applies the drive current to the chip 201 at the time when the transmission of the cooling heat from the Peltier TEC 205 to the chip 201 starts (refer to (1) Drive current in FIG. 7). The drive current is applied substantially simultaneously with the input of the input signal into the chip 201 (or the variation in the input signal).

In the chip 201, the increase in temperature due to the self heating of the chip 201 advances concurrently with the decrease in temperature due to the Peltier cooling heat. Accordingly, if the amount of self heating of the chip 201 is equal to the amount of cooling heat from the Peltier TEC 205, the chip temperature is not varied. However, the chip temperature may practically be varied because of, for example, the temperature distribution of the heating state in the chip 201 (the distribution is not uniform) or the Peltier cooling heat that is smaller or larger than the amount of heat generated in the chip per unit time (refer to (4) Chip temperature in FIG. 7). In addition, the optical output and the thermistor temperature are also varied in accordance with the variation in the chip temperature (refer to (3) Optical output and (5) Thermistor temperature in FIG. 7).

The control of the Peltier current the thermal time constant t1 before the application of the drive current has advantages. For example, the amount of variation in the optical output may be decreased when the temperature control of the chip 201 is started as soon as possible since the increase in the chip temperature (refer to (3) Optical output in FIG. 7). This is because it takes a shorter time to return the state in which the variation in temperature is small to the original temperature state, compared with a case in which the state in which the variation in temperature is large is returned to the original temperature state.

In addition, upon stop of the application of the drive current, the Peltier current may be stopped the thermal time constant t1 before the stop of the application of the drive current (refer to (2) Peltier current in FIG. 7). This prevents the chip 201 from being over-cooled with the Peltier cooling heat to suppress the variation in optical output.

As described above, according to the present embodiment, the Peltier current is controlled prior to the application of the drive current. Accordingly, it is possible to suppress the variation in the chip temperature to increase the speed of the temperature control of the chip 201.

In addition, according to the present embodiment, since the chip temperature is converged before the chip temperature is greatly varied, it is possible to decrease the amount of Peltier current to be supplied to the Peltier TEC 205 to greatly reduce the power consumption.

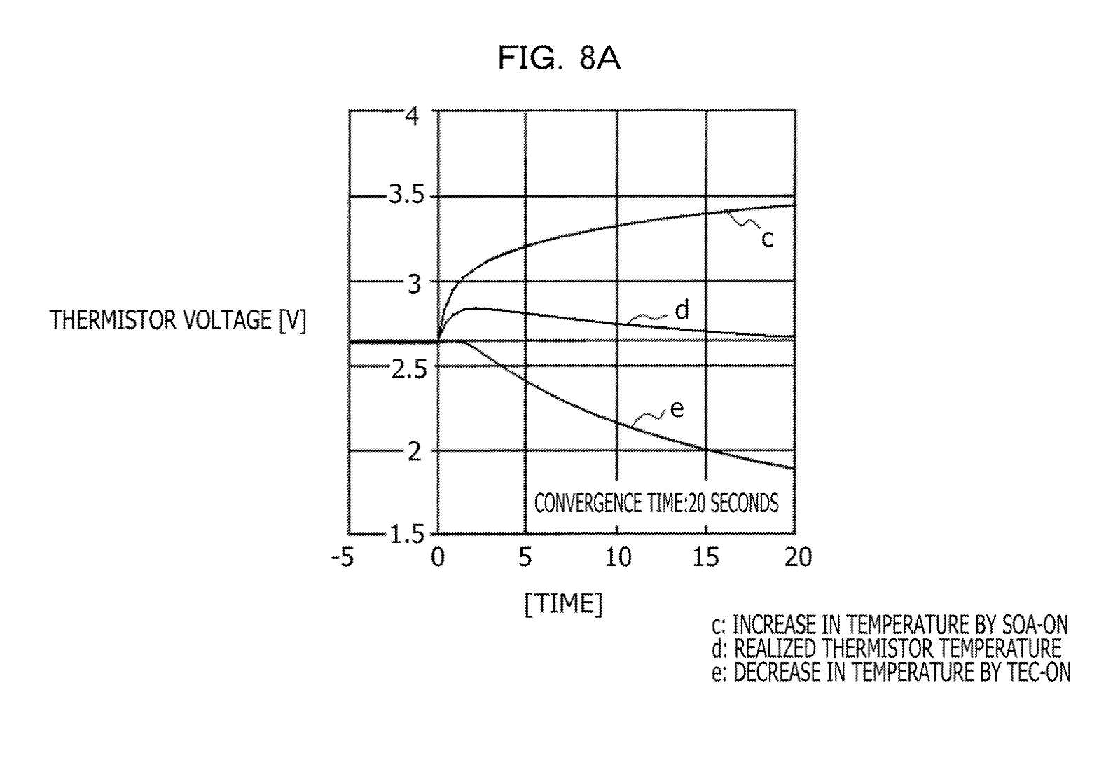

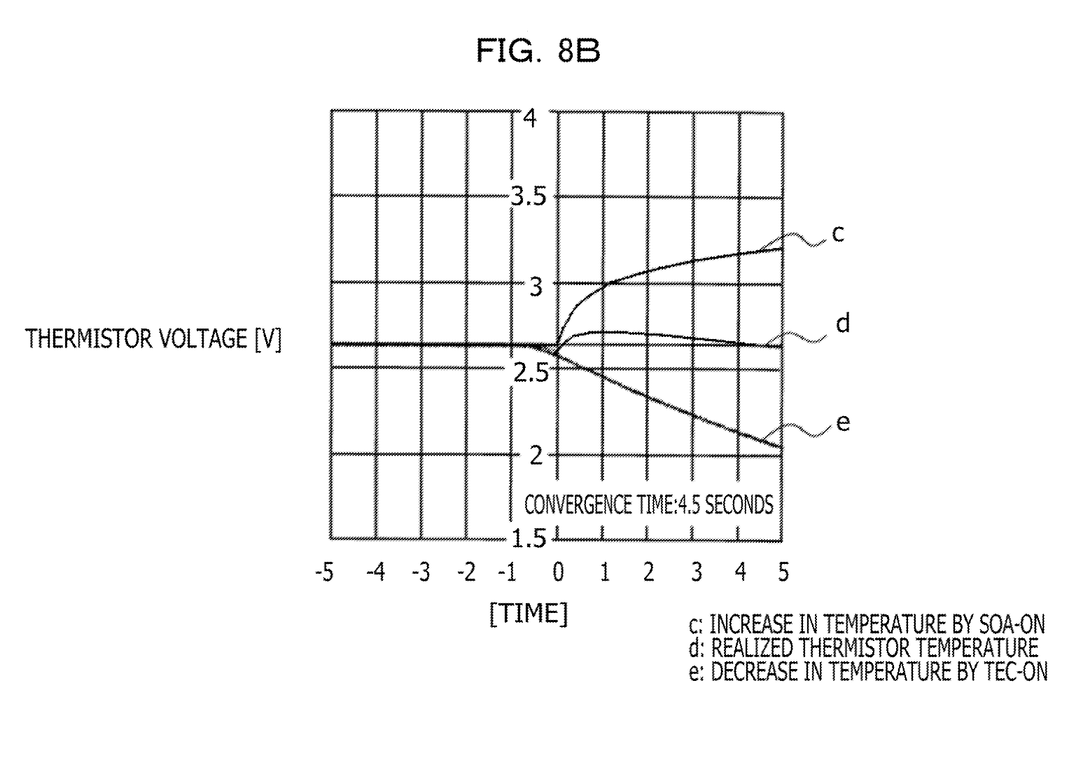

The temperature variation in the feedback temperature control will now be compared with the temperature variation in the feedforward temperature control with reference to FIGS. 8A and 8B. FIG. 8A illustrates an example of how the chip temperature is varied with time in the feedback temperature control. FIG. 8B illustrates an example of how the chip temperature is varied with time in the feedforward temperature control.

In both the examples in FIG. 8A and FIG. 8B, the vertical axis represents the thermistor voltage [V] (corresponding to the thermistor temperature) and the horizontal axis represents time [sec]. Reference letter c denotes the variation in temperature in the thermistor 202 when no Peltier current is applied to the Peltier TEC 205 and a drive current of 300 mA is applied to the chip 201. Reference letter e denotes the variation in temperature in the thermistor 202 when no drive current is applied to the chip 201 and a Peltier current is applied to the Peltier TEC 205. Reference letter d results from a combination of the variation in temperature in the thermistor 202 denoted by reference letter c and the variation in temperature in the thermistor 202 denoted by reference letter e and denotes the variation in temperature in the thermistor 202 when a drive current is applied to the chip 201 and a Peltier current is applied to the Peltier TEC 205.

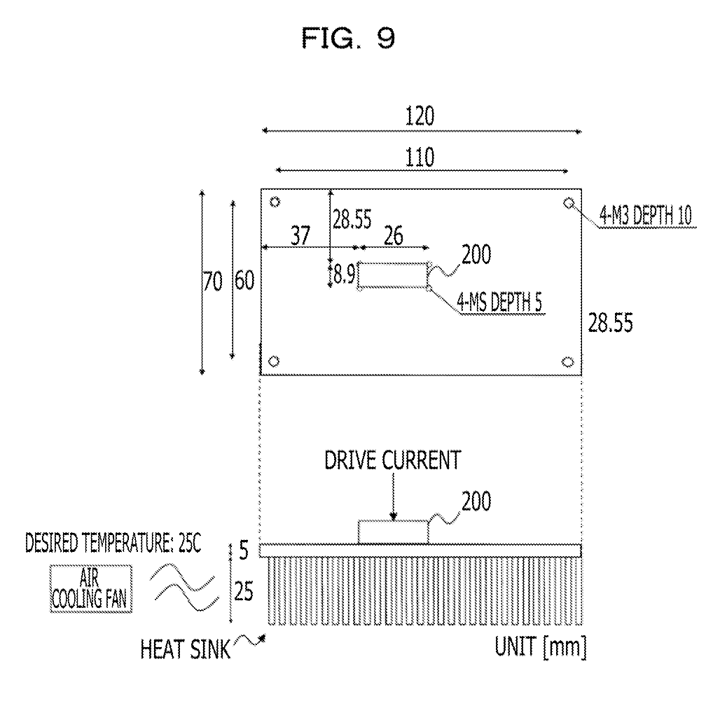

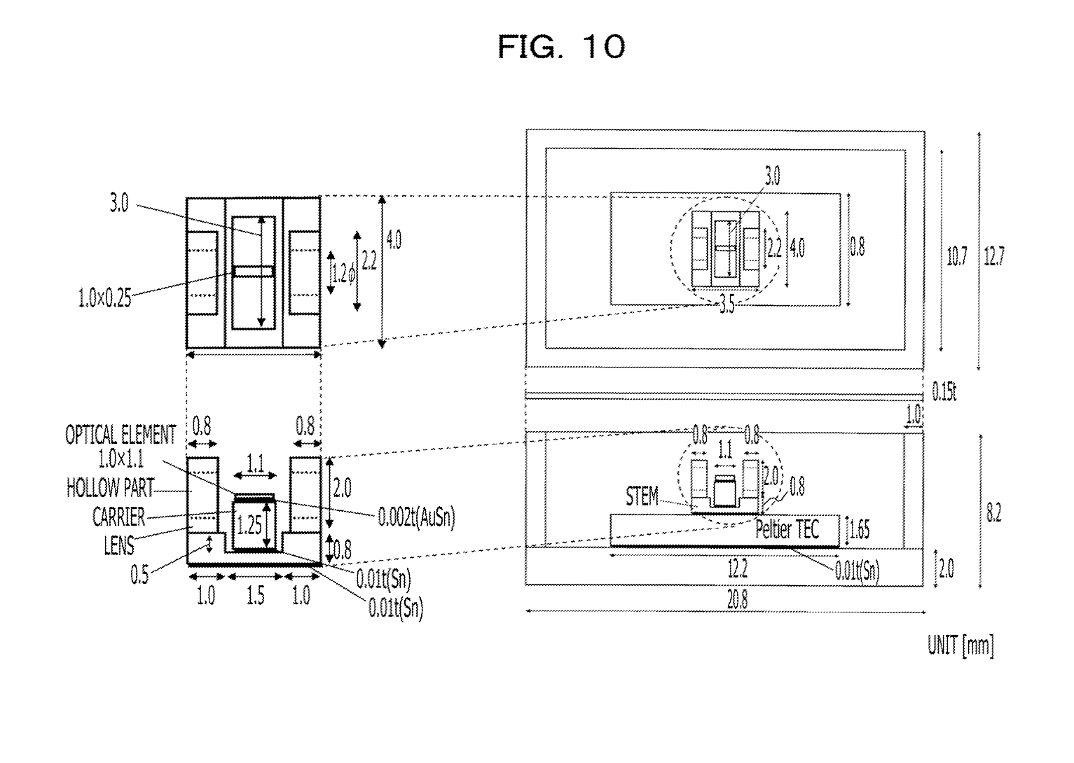

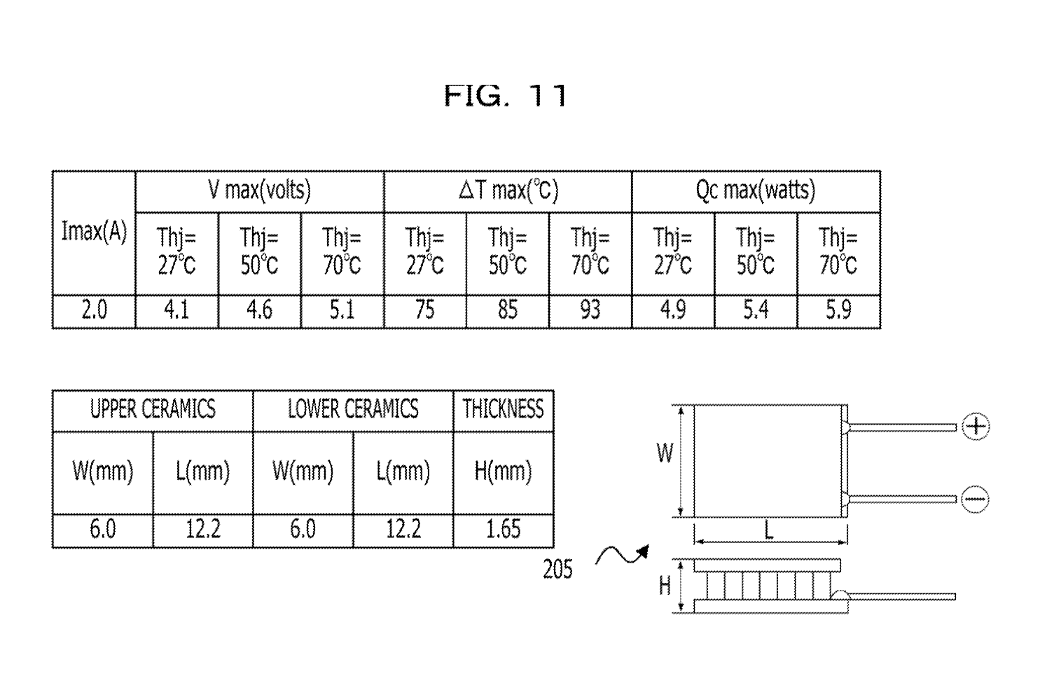

Examples of the configurations of the optical module 200 and the Peltier TEC 205 used in the measurements illustrated in FIG. 8A and FIG. 8B are illustrated in FIGS. 9 to 11. FIG. 9 illustrates an example of the arrangement of the optical module 200. FIG. 10 illustrates an example of the configuration of the optical module 200. FIG. 11 illustrates an example of the configuration of the Peltier TEC 205 and parameters.

In the example in FIG. 9, an SOA element is hermetically sealed in a Multi Source Agreement (MSA)-compliant 14-pin butterfly package for optical communication. A heat sink has a thermal resistance of about 4° C./W and is forcedly cooled at a wind velocity of about 0.4 m³/min with an air cooling fan. The ambient temperature of the optical module 200 is set to 25° C. and the desired control value of the chip temperature is set to 25° C.

An example of the internal configuration of the optical module 20 is illustrated in FIG. 10. The chip 201 is made of an indium phosphide (InP) material and the carrier 203 is made of aluminum nitride (AlN). In addition, SUS430 is used as the external frame of the lens, the stem 204 and the side walls of the package are made of Kovar, and the bottom plate of the package is made of copper tungsten (CuW).

An example of the configuration of the Peltier TEC 205 and various parameters used in the Peltier TEC 205 are illustrated in FIG. 11.

As illustrated in FIG. 8A, in the feedback temperature control, the drive current is started to be applied to the chip 201 and the thermistor 202 is increased in temperature at a time 0. As illustrated by reference letter c in FIG. 8A, the thermistor temperature is increased from the initial temperature by about 25° C. (by about 800 mV in the thermistor voltage) when the cooling of the chip 201 is not performed by the Peltier TEC 205. In this case, the thermistor temperature is sharply increased for about first one to two seconds.

After the thermal time constant t2 elapsed since the time 0, the thermistor 202 detects a change in temperature of the chip 201 and the temperature control by the Peltier TEC 205 is started. As illustrated by reference letter e in FIG. 8A, the thermistor temperature decreases about two seconds after the heat generation in the chip 201. This time period corresponds to “t2+t3+control time.”

As illustrated by reference letter d in FIG. 8A, since the temperature control by the Peltier TEC 205 is started a certain time after the heat generation in the chip 201 in the feedback temperature control, the width of shift in temperature is large and it takes about 20 seconds until the chip temperature converging, which corresponds to recovery time.

In contrast, as apparent from the curve denoted by reference letter e in FIG. 8B, the supply of the Peltier current to the Peltier TEC 205 is started before the application of the drive current to the chip 201 in the present embodiment.

Accordingly, as illustrated by reference letter d in FIG. 8B, the width of shift in temperature is smaller than that in the example in FIG. 8A and it takes about 4.5 seconds until the chip temperature converging.

The chip 201, the thermistor 202, the carrier 203, the stem 204, and the Peltier TEC 205 used for the measurement in the example in FIG. 8A are the same as the ones used for the measurement in the example in FIG. 8B.

However, since the Peltier TEC 205 used in the above measurement is a Peltier element based on an idea in the related art, the Peltier TEC 205 does not have a superior cooling capacity. It is possible to use the Peltier TEC 205 having cooling curves symmetric to the heat generation curves illustrated by reference letter c in the example in FIG. 8A and the example in FIG. 8B with respect to the time axis. Since the Peltier TEC 205 used in this experiment has a lower cooling capacity and the amount of heat generated in the chip 201 is not removed with the Peltier cooling heat, it takes about 4.5 seconds to converge the chip temperature. However, the use of the Peltier TEC 205 having a higher cooling capacity allows the speed of the temperature convergence in the chip 201 to be increased.

As described above, it is possible to have the Peltier TEC 205 used in the present embodiment selected based on, for example, the heat generation curve of the chip 201.

In the feedback temperature control illustrated in FIG. 8A, since it takes about two seconds to detect a change in temperature of the chip 201 even if the cooling capacity of the Peltier TEC 205 is improved, it is not possible to cause the convergence time of the chip temperature to be decreased to two seconds or less.

The thermal time constants t1 to t3 of the optical module 200 are measured and determined by only applying the drive current to the chip 201 or only applying the Peltier current to the Peltier TEC 205, as described above.

(1.5) Method of Calculating Amount of FF Control

How to calculate the amount of Peltier current (the amount of FF control) concerning the feedforward control will now be described.

For example, in the use of an SOA as the chip 201, since a substantially constant amount of heat is generated in the chip 201 with a substantially constant amount of drive current applied, the amount of cooling heat by the Peltier TEC 205 is also constant.

However, when the input signal into the optical module 200 is varied, the drive current is varied in accordance with the variation in the input power (level) at a substantially constant output power (level). As a result, the amount of self heating in the chip 201 is also varied.

Accordingly, according to the present embodiment, the current controller 106 calculates (determines) the amount of FF control based on, for example, the drive current value, the desired temperature in the optical module 200, and the ambient temperature of the optical module 200 and supplies the amount of FF control to the Peltier TEC 205 the thermal time constant t1 before the application of the drive current.

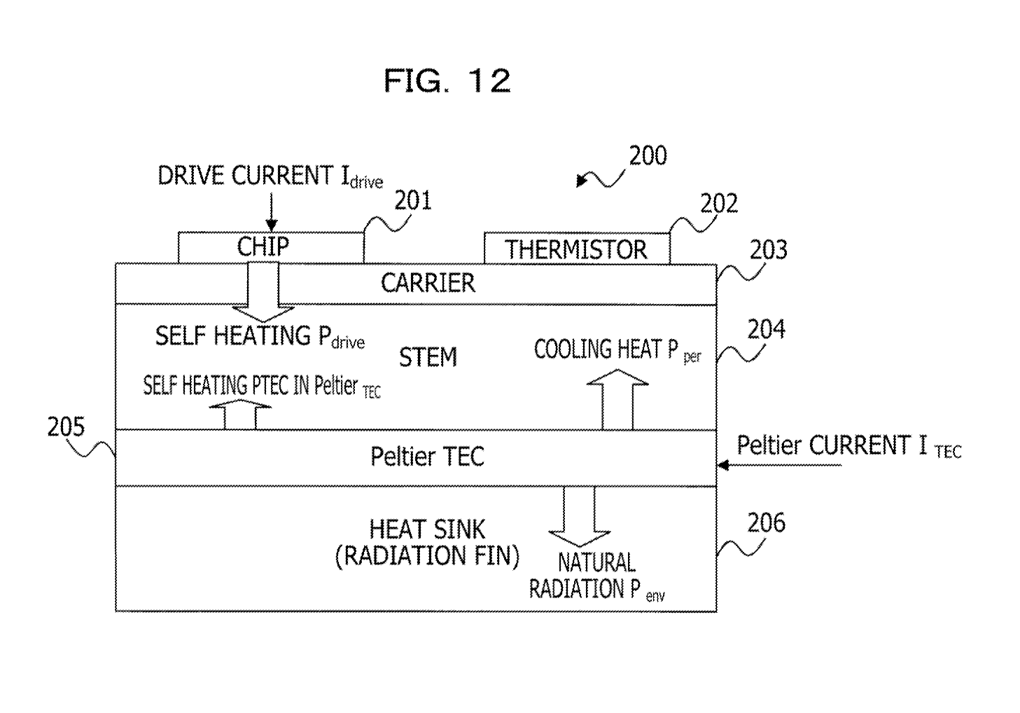

FIG. 12 illustrates an example of the relationship of input and output of heat in the optical module 200. The optical module 200 in FIG. 12 includes, for example, a heat sink (radiation fin) 206, in addition to the components illustrated in FIG. 2. Since the heat is naturally radiated from other components in the optical module 200 even when the optical module 200 does not include the heat sink 206, the following calculation method is applicable to such a case.

The system illustrated in FIG. 12 has, for example, an amount of self heating P_{drive} in the chip 201, which is in proportion to the square of an amount of drive current I_{drive} applied to the chip 201, and an amount of self heating P_{TEC} in the Peltier TEC 205, which is in proportion to the square of an amount of Peltier current I_{TEC}, as heat generating components. The amount of self heating P_{TEC} is caused by, for example, the resistance component in the Peltier TEC 205.

The system illustrated in FIG. 12 has, for example, an amount of cooling heat Pₚₑᵣ that is in proportion to the amount of Peltier current I_{TEC} and an amount of natural radiation Pₑₙᵥ that is in proportion to a difference ΔT between the desired control value (desired temperature) in the chip 201 and the ambient temperature of the optical module 200, as cooling (heat radiating) components. The desired temperature is set by, for example, a user. If the heat sink 206 is subjected to, for example, intelligent forced air cooling (for example, control of the number of revolutions of a built-in fan in accordance with the chip temperature), the amount of natural radiation Pₑₙᵥ may be intricately varied. However, when the heat sink 206 is subjected to forced air cooling in which a certain amount of airflow is applied to the radiation fin in the heat sink 206, the amount of natural radiation Pₑₙᵥ is in proportion to the difference ΔT between the desired temperature in the chip 201 and ambient temperature.

Accordingly, for example, Equations (1) to (4) are established where reference letters A to D denote constants (A to D≠0):

P_{drive}=A×I_{drive}² (1)

P_{TEC}=B×I_{TEC}² (2)

Pₚₑᵣ=C×I_{TEC} (3)

Pₑₙᵥ=D×ΔT (4)

In addition, since the amount of generated heat (P_{drive}+P_{TEC}) is balanced with the amount of cooling (Pₚₑᵣ+Pₑₙᵥ) in a state in which the chip temperature is (Pₚₑᵣ converged, Relational expression (5) is established:

P_{drive}+P_{TEC}=Pₚₑᵣ+Pₑₙᵥ (5)

Rewriting Relational expression (5) by using Equations (1) to (4) results in Equation (6):

A×I_{drive}²+B×I_{TEC}²=C×I_{TEC}+D×ΔT (6)

Solving Equation (6) as a quadratic equation of the amount of Peltier current I_{TEC} results in Equation (7):

$${I}_{TEC} = \frac{C \pm \sqrt{{C}^{2} - 4 B ( A \times {I}_{drive}^{2} - D \times Δ T )}}{2 B} \qquad ( 7 )$$

Since A to D are known constants, the amount of Peltier current I_{TEC} (the amount of FF control) is calculated from Equation (7) with the specified amount of driving current I_{drive} and difference ΔT.

The amount of drive current I_{drive} is calculated from information about, for example, the input signal. For example, when the chip 201 is an SOA, the current controller 106 calculates the amount of drive current I_{drive} for acquiring a desired output level (power) corresponding to the specified level (power) of the input signal. When the chip 201 is a tunable LD, the current controller 106 calculates the amount of drive current I_{drive} based on the specified control wavelength for the tunable LD.

However, it may not possible to calculate the difference ΔT because the external temperature (ambient temperature) of the chip 201 may not be detected only with the thermistor 202 (a second temperature sensor) provided in the optical module 200.

Accordingly, according to one embodiment, the provision of the temperature sensor 11 outside the optical module 200 allows the ambient temperature to be detected.

As a result, it is possible to calculate the difference ΔT between the desired temperature and the ambient temperature detected by the temperature sensor 11. In order to suppress an increase in temperature of the chip 201 due to the application of the drive current, a temperature detected by the thermistor 202 provided in the optical module 200 before the application of the drive current may be used as the desired temperature.

The amount of Peltier current I_{TEC} (the amount of FF control) is calculated from Equation (7) with the amount of drive current I_{drive} and the difference ΔT in the above manner.

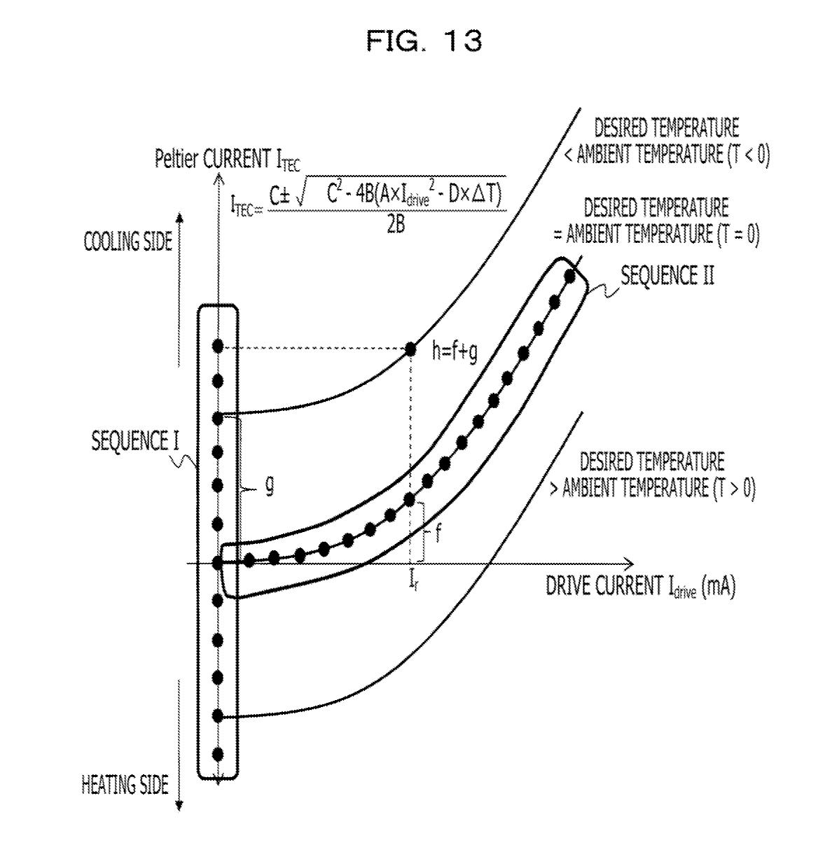

FIG. 13 illustrates an example of the relationship between the drive current I_{drive} and the Peltier current I_{TEC}.

As illustrated in FIG. 13, when the desired temperature substantially equals to the ambient temperature (ΔT=0), I_{TEC}=0 mA with I_{drive}=0 mA because the self heating does not occur in the chip 201 and it is not necessary to drive the Peltier TEC 205.

When the desired temperature is lower than the ambient temperature (ΔT<0), the temperature of the chip 201 comes close to the ambient temperature even if I_{drive}=0 mA. Accordingly, the Peltier TEC 205 is caused to cool the chip 201 and the amount of Peltier current I_{TEC} is equal to a certain current value at the cooling side.

In contrast, when the desired temperature is higher than the ambient temperature (ΔT>0), the chip 201 is heated even if I_{drive}=0 mA and the amount of Peltier current I_{TEC} substantially equals to a certain current value at the heating side.

In any of the above cases, since the amount of self heating in the chip 201 is increased with the increasing amount of drive current I_{drive}, the chip 201 is cooled by the amount corresponding to the increase in the amount of self heating and the amount of Peltier current I_{TEC} is also increased. Accordingly, the amount of Peltier current I_{TEC} is moved upward (toward the cooling side) from the start point (I_{drive}=0 mA) in the graph in FIG. 13 with the increasing amount of drive current I_{drive}.

Accordingly, in the present embodiment, the desired temperature is changed with the amount of drive current I_{drive}=0 mA to acquire the amount of Peltier current I_{TEC} (a sequence I) at which the chip temperature becomes substantially equal to the desired temperature subjected to the change, that is, the temperature equilibrium state of the optical module 200 is kept in advance (for example, during shipping test of the optical module 200). In addition, the amount of drive current I_{drive} is changed with the difference ΔT=0 to acquire the amount of Peltier current I_{TEC} (a sequence II) at which the chip temperature becomes substantially equal to the desired temperature at each amount of drive current I_{drive}, that is, the temperature equilibrium state of the optical module 200 is kept in advance. The acquisition of the sequence I and the sequence II before the drive of the optical module 200 allows the amount of Peltier current I_{TEC} corresponding to each amount of drive current I_{drive} and each difference ΔT (for example, in the entire range of the amount of drive current I_{drive} and in the entire range of the difference ΔT) to be calculated, that is, allows the amount of FF control to be calculated.

With the difference ΔT specified, the amount of Peltier current I_{TEC}=g at the specified difference ΔT is acquired from the sequence I. For example, when the chip 201 is an SOA, the amount of drive current I_{drive} is calculated from the level of the input signal input into the SOA.

If I_{drive}=I_{f}, an increment f of the amount of Peltier current I_{TEC} is acquired e from the sequence II and the amount of Peltier current I_{TEC}=h at which the temperature equilibrium state of the optical module 200 is kept at the above difference ΔT and the above amount of drive current I_{drive} is calculated from Equation (8):

h (the amount of Peltier current at which the temperature equilibrium state of the difference ΔT is kept)=g [the amount of Peltier current at which the temperature equilibrium state of the difference ΔT is kept when I_{drive}=0 (from the sequence I)]+f [the amount of Peltier current at which the temperature equilibrium state when I_{drive}=I_{f} is kept when ΔT=0 (from the sequence II)] (8)

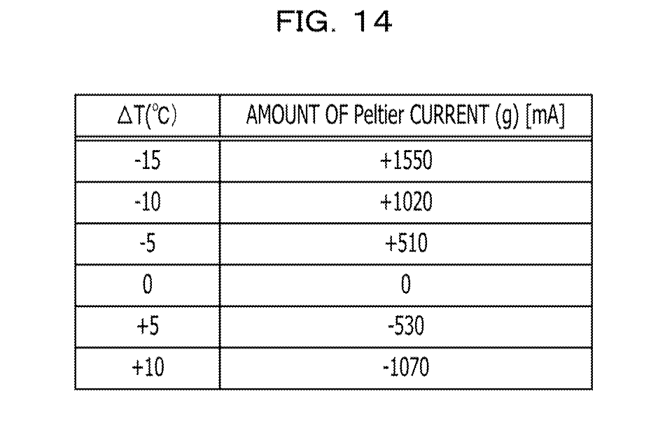

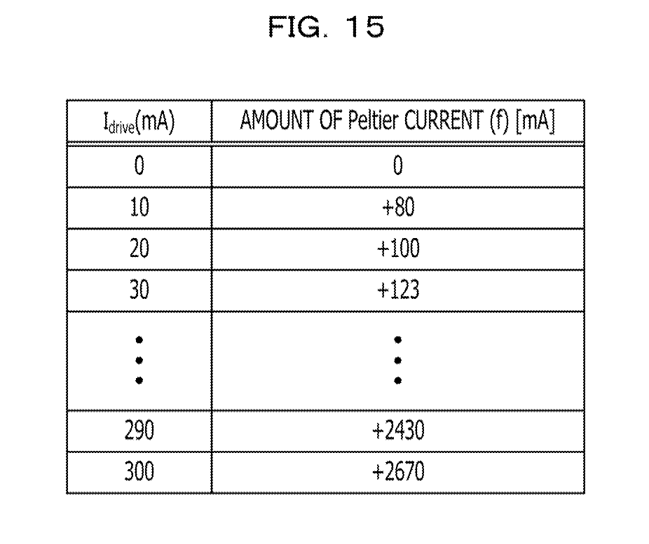

FIG. 14 illustrates examples of the amounts of Peltier current in the sequence I, and FIG. 15 illustrates examples of the amounts of Peltier current in the sequence II. The cooling is performed by the Peltier TEC 205 when the amount of Peltier current has a positive value (+) whereas the heating is performed by the Peltier TEC 205 when the amount of Peltier current has a negative value (−).

Referring to FIG. 14, for example, when ΔT=−15° C., the amount of Peltier current g required to keep the equilibrium state of the chip temperature is substantially equal to +1,550 mA. When ΔT=−10° C., −5° C., 0° C., +5° C., or +10° C., the amount of Peltier current g required to keep the equilibrium state of the chip temperature is equal to +1,020 mA, +510 mA, 0 mA, −530 mA, or −1,070 mA, respectively.

Referring to FIG. 15, for example, when I_{drive}=10 mA, the amount of Peltier current f required to keep the equilibrium state of the chip temperature is substantially equal to +80 mA. When I_{drive}=20 mA, 30 mA, . . . , 290 mA, or 300 mA, the amount of Peltier current f required to keep the equilibrium state of the chip temperature is substantially equaled to +100 mA, +123 mA, . . . , +2,430 mA, or +2,670 mA, respectively.

The results of measurement illustrated in FIGS. 14 and 15 are only examples. The measurement ranges of the difference ΔT and the amount of drive current I_{drive} may be expanded or narrowed and/or a smaller or larger measurement width (step width) may be set.

Examples of a temperature control method and the operation of the optical device 300 according to the present embodiment will now be described. In the following examples, for example, the temperature detected by the thermistor 202 prior to the application of the drive current is set as the desired temperature in order to suppress an increase in the chip temperature caused by the application of the drive current.

First, for example, during the shipping test of the optical device 300, the current controller 106 acquires the measurement values, as illustrated in the examples in FIGS. 14 and 15. The current controller 106 then acquires the thermal time constant t1 of the optical module 200 by, for example, the method described above with reference to FIG. 14. In addition to the thermal time constant t1, the thermal time constants t2 and t3 may be acquired.

Then, for example, during the operation of the optical device 300, the current controller 106 calculates the amount of drive current I_{drive} for keeping a constant output level based on information (a variation in the input signal, wavelength control signals, etc.) about the input signal.

Then, the current controller 106 calculates the difference ΔT between the result of measurement of the ambient temperature by the temperature sensor 11 and the result of measurement of the chip temperature (the desired temperature) by the thermistor 202 to calculate the amount of Peltier current I_{TEC} (g) corresponding to the calculated difference ΔT based on the result of measurement illustrated in FIG. 14.

Then, the current controller 106 calculates the amount of Peltier current I_{TEC} (f) corresponding to the calculated amount of drive current I_{drive} based on the result of measurement illustrated in FIG. 15.

Then, the current controller 106 adds the calculated amount of Peltier current I_{TEC} (g) to the amount of Peltier current I_{TEC} (f) to calculate the amount of FF control and applies the amount of FF control to the Peltier TEC 205 as the amount of Peltier current I_{TEC} the thermal time constant t1 before the input of the input signal into the chip 201.

Then, the current controller 106 applies the calculated amount of drive current I_{drive} to the chip 201 the thermal time constant t1 after the application of the amount of Peltier current I_{TEC}, that is, at the time when the input signal is input into the chip 201.

As described above, according to the present embodiment, since the amount of Peltier current I_{TEC} is controlled the thermal time constant t1 before the application of the amount of drive current I_{drive}, it is possible to control the chip temperature so as to have a substantially constant value before the temperature of the chip 201 is greatly changed, thus realizing the stabilization of the optical output and the increase in speed of the temperature control.

Also upon stop of the supply of the drive current I_{drive}, it is possible to rive suppress a large change in the chip temperature, for example, if the application of the Peltier current I_{TEC} is stopped the thermal time constant t1 before the stop of the application of the drive current I_{drive}, thus realizing the increase in speed of the temperature control of the optical device 300.

### [2] First Modification

Although the example in which the chip temperature is subjected to the feedforward control is described above, both the feedforward temperature control and the feedback temperature control may be used (hybrid control).

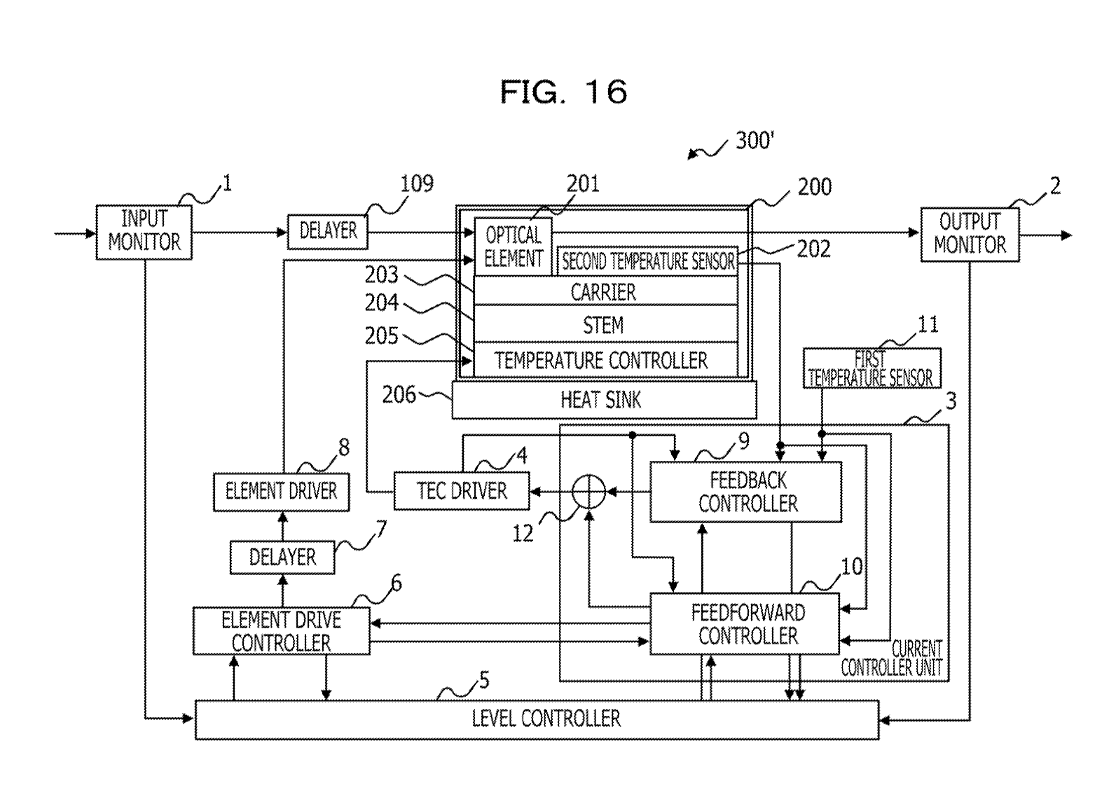

FIG. 16 illustrates an example of the configuration of an optical device 300′ according to a first modification.

The optical device 300′ in FIG. 16 includes, for example, an input monitor 1, the delayer 109, the optical module 200, an output monitor 2, the heat sink 206, the temperature sensor 11, and a current controller unit 3. The optical device 300′ also includes, for example, a TEC driver 4, a level controller 5, an element drive controller 6, a delayer 7, and an element driver 8.

The input monitor 1 converts an optical signal that is input into an electrical signal and monitors the strength of the electrical signal. The input monitor 1 supplies the result of the monitoring (input level monitoring result) to the level controller 5 and splits the input signal to supply the resulting signal to the delayer 109.

The delayer 109 gives a certain delay to the received optical signal. The delayer 109 of the first modification gives, for example, at least a delay corresponding to the thermal time constant t1 to the input signal.

The optical module 200 performs certain optical processing to the input signal. Accordingly, the optical module 200 of the first modification includes, for example, an optical element (chip) 201, a thermistor 202, a carrier 203, a stem 204, and a temperature controller (for example, Peltier TEC) 205. For example, when the optical element 201 is an SOA, the optical module 200 may perform optical amplification or optical attenuation to the input signal. Specifically, the optical module 200 of the first modification amplifies or attenuates the input signal so as to output an optical signal of a substantially constant level under the control of the element driver 8. The optical element 201, the thermistor 202, the carrier 203, the stem 204, and the temperature controller 205 of the first modification have functions similar to those of the chip 201, the thermistor 202, the carrier 203, the stem 204, and the Peltier TEC 205 described above.

The output monitor 2 converts an optical signal that is input into an electrical signal and monitors the strength of the electrical signal. The output monitor 2 supplies the result of monitoring (output level monitoring result) to the level controller 5 and splits the output signal from the optical element 201 to output the resulting signal outside the optical device 300′.

The heat sink (radiation fin) 206 externally radiates the heat generated in the optical module 200. The heat sink 206 of the first modification, for example, receives a certain amount of airflow from an air blower (fan) to externally radiate the amount of heat in the optical module 200.

The temperature sensor 11 measures the ambient temperature of the optical element 201. The result of measurement by the temperature sensor 11 is supplied to the current controller unit 3 (a feedback controller 9 and a feedforward controller 10).

The current controller unit 3 controls the Peltier current and the drive current to be supplied to the optical module 200 based on, for example, the chip temperature detected by the thermistor 202, the ambient temperature detected by the temperature sensor 11, and a variety of control information from the level controller 5. Accordingly, the current controller unit 3 includes, for example, the feedback controller 9, the feedforward controller 10, and an adder 12.

The feedback controller 9 performs the feedback control of the Peltier current based on the input level monitoring result detected by the input monitor 1 and the output level monitoring result detected by the output monitor 2. The amount of Peltier current calculated by the feedback controller 9 is supplied to the adder 12. The feedback controller 9 of the first modification may perform a variety of feedback control based on, for example, the result of temperature detection in the thermistor 202 and the temperature sensor 11, the amount of Peltier current from the TEC driver 4, and the thermal time constants t2 and t3.

The feedforward controller 10 calculates the amount of FF control based on, for example, the input level monitoring result detected by the input monitor 1, the result of measurement of the chip temperature in the thermistor 202, the result of measurement of the ambient temperature in the temperature sensor 11, and information about the amount of drive current from the element drive controller 6. The amount of FF control calculated by the feedforward controller 10 is supplied to the adder 12.

The adder 12 adds the amount of Peltier current calculated by the feedback controller 9 to the amount of FF control calculated by the feedforward controller 10. The result of addition in the adder 12 is supplied to the TEC driver 4. With this configuration, the optical device 300′ of the first modification performs the hybrid control in which the feedback control is combined with the feedforward control.

The control time in the feedforward control is equal to, for example, the sum of the calculation time in the feedforward controller 10 and the thermal time constant t1. In the feedforward control, for example, a rapid variation in the chip temperature is followed and the precision of the temperature control is improved with parameters concerning the temperature control acquired in advance. However, the feedforward control may not respond to a slow response, such as a variation in the environmental temperature (ambient temperature) of the optical element 201.

In contrast, the control time in the feedback control is equal to, for example, the result of multiplication of the sum of the thermal time constants t1 and t2 and the calculation time in the feedback controller 9 by the number of times of feedback loops. Although the feedback control does not have the rapid response performance as in the feedforward control, the feedback control is characterized by being appropriate for the slow response, such as a change in the ambient temperature. In addition, since the temperature control is performed while monitoring the chip temperature in the feedback control, it is possible to improve the precision of the medium-to-long-term temperature control.

Since the current controller unit 3 adopts both the feedback temperature control and the feedforward temperature control in the first modification, it is possible to achieve the rapid temperature control and the medium-to-long-term output stability, thus realizing a further increase in speed of the output signal and the stabilization thereof.

The feedforward temperature control cannot be performed without the amount of heat generated in the entire system that is predicted in advance. Accordingly, the current controller unit 3 of the first modification measures the tables illustrated in FIGS. 14 and 15 in advance in the above manner to predict the amount of heat generated in the optical element 201. The current controller unit 3 controls the drive current (the Peltier current) to be supplied to the temperature controller 205 prior to, for example, the application (or variation) of the input signal or the drive current.

For example, since the current controller unit 3 controls the Peltier current the thermal time constant t1 before the application (or variation) of the input signal or the drive current to vary the temperature of the temperature controller 205, the heating and the cooling proceeds substantially concurrently in the optical element 201 and, thus, the chip temperature is kept to a substantially constant value.

In addition, since the optical device 300′ of the first modification adopts both the feedforward temperature control and the feedback temperature control, for example, it is possible for the optical device 300′ to respond to a sharp variation in the chip temperature caused by, for example, turning on and off of the input signal with the feedforward temperature control and to respond to a slow variation in the chip temperature caused by the change in the ambient temperature with the feedback temperature control.

As a result, it is possible to rapidly realize the stabilization of the output of the chip temperature.

The TEC driver 4 drives the temperature controller 205 by using the Peltier current supplied from the adder 12. The TEC driver 4 may notify the feedback controller 9 and the feedforward controller 10 of information about the amount of Peltier current supplied to the temperature controller 205.

The level controller 5 notifies the element drive controller 6, the feedback controller 9, the feedforward controller 10, etc. of various control signals based on the input level monitoring result detected by the input monitor 1 and the output level monitoring result detected by the output monitor 2. The control signals include, for example, information about the variation in the input signal (the time when the input signal is varied and the amount of variation).

The element drive controller 6 generates the drive current used to drive the optical element 201 based on the control signals notified from the level controller 5. The element drive controller 6, for example, generates the drive current at the time when the input signal is received and varies the amount of drive current at the time when the input signal is varied. The drive current generated by the element drive controller 6 is supplied to the delayer 7.

The delayer 7 gives a certain delay to the drive current supplied from the element drive controller 6. The delay given to the drive current by the delayer 7 may be equal to, for example, the delay (for example, the thermal time constant t1) given to the input signal by the delayer 109. In this case, the application (or variation) of the input signal is synchronized with the application (or variation) of the drive current. The amount of delay in the delayer 7 may be controlled by, for example, the element drive controller 6.

The element driver 8 drives the optical element 201 by using the drive current received from the delayer 7.

An example of the operation of the optical device 300′ of the first modification will now be described.

First, the level controller 5 acquires information about the variation in the input signal detected by the input monitor 1. The level controller 5 may externally acquire information about the input signal, for example, before the input signal is input into the input monitor 1. When the level controller 5 acquires the above information the thermal time constant t1 or more before the input of the input signal, the delayer 109 and the delayer 7 may be removed from the configuration of the optical device 300′ illustrated in FIG. 16.

Then, the level controller 5 calculates the temperature settings and control information in the optical element 201 based on the above information and notifies the feedback controller 9 and the feedforward controller 10 of the desired temperature value and the control parameters (the drive current value, etc.) in the optical element 201.

At this time, for example, the feedback controller 9 may temporarily stop the feedback temperature control until the processing in the feedforward controller 10 is completed.

Then, the feedforward controller 10 calculates the temperature difference ΔT based on the result of detection (the chip temperature) in the thermistor 202 and the result of detection (the ambient temperature) in the temperature sensor 11.

The current controller unit 3 calculates the amount of FF control (the amount of Peltier current I_{TEC}) from the table concerning the sequence I illustrated in FIG. 14 and the table concerning the sequence II illustrated in FIG. 15 based on the drive current value (I_{drive}) notified from the level controller 5 and the calculated temperature difference ΔT.

The TEC driver 4 drives the temperature controller (for example, the Peltier TEC) by using the Peltier current calculated by the feedback controller 9 and the feedforward controller 10. The feedforward controller 10 notifies the element drive controller 6 of the driving of the temperature controller 205 (the time when the temperature controller 205 is driven).

The element drive controller 6 generates the amount of drive current notified from the level controller 5 at the driving time notified from the feedforward controller 10 and outputs the generated amount of drive current. The delayer 7 gives a certain delay (for example, the delay corresponding to the thermal time constant t1) to the drive current output from the element drive controller 6 and supplies the drive current to which the delay is given to the element driver 8. The element driver 8 drives the optical element 201 by using the drive current supplied from the delayer 7. Accordingly, the drive current is applied to the optical element 201 the thermal time constant t1 after the Peltier current is applied to the temperature controller 205. The input signal is also applied to the optical element 201 the thermal time constant t1 after the Peltier current is applied to the temperature controller 205. Consequently, the cooling control (the feedforward temperature control) by the temperature controller 205 is performed the thermal time constant t1 before the chip temperature is increased due to the application of the drive current.

When the feedforward temperature control is completed, the feedback controller 9 starts (restarts) the feedback control of the chip temperature. For example, the feedback controller 9 may continue the feedback temperature control while no sharp variation in the chip temperature caused by, for example, turning on and off of the drive current occurs.

Upon stop of the application of the drive current, the current controller unit 3 performs the feedforward control of the Peltier current in an operation similar to the above operation. The feedforward control may be started, for example, in response to a variation in the input signal or a variation in the driving state of the optical element 201.

Consequently, the optical device 300′ of the first modification stabilizes the temperature within a few seconds or less even when the drive current is increased, thus decreasing the variation width of the output signal. For example, when the optical element 201 is an SOA, the output is varied for about 30 seconds to 100 seconds and the output power has a large variation width of about 2.5 dB to 3.5 dB in the related art. In contrast, according to the first modification, it is possible to stabilize the chip temperature within a few seconds or less since the variation in the drive current and to decrease the variation width of the output power to about ½ to 1/10 of the ones in the related art.

### [3] Second Modification

The input signal light may be Wavelength Division Multiplexing (WDM) signal light. In this case, the optical module 200 may be configured as, for example, an N-array element including multiple chips 201, where “N” is an integer that is not smaller than two. The optical module 200 configured as an N-array element includes the multiple chips 201 in the longitudinal direction in the configuration illustrated in FIG. 2. This configuration is only an example and the optical module 200 may be configured as an N-array element with various other configurations.

For example, multiple circular chips 201 may be provided around the thermistor 202.

In this case, N-number chips 201 may be controlled by multiple Peltier TECs 205 or may be controlled by one Peltier TEC 205.

Since the N-array element is manufactured so that the chips 201 have various uniform characteristics, the amount of heat generated in the entire optical module 200 is in proportion to the number of chips 201 that are simultaneously driven with a substantially-constant drive current applied to all the chips 201. For example, when a substantially constant drive current is applied to two chips 201, the amount of heat generated in the two chips 201 is twice the amount of heat generated when the drive current is applied to one chip 201.

Consequently, as apparent from the relationship in Equation (1), since an amount of heat (P_{drive}_{_{—}}_{N}) generated in the optical module 200 configured as an N-array element is in proportion to the sum of the squares of amounts of drive current (I_{drive}_{_{—}}₁, . . . , I_{drive}_{_{—}}_{N}) applied to the chips 201, Equation (9) is established:

$${P}_{drive \_ N} ∝ {( {I}_{drive \_ 1} )}^{2} + {( {I}_{drive \_ 2} )}^{2} + … + {( {I}_{drive\_N} )}^{2} = {\sum }_{k = 1}^{N} {( {I}_{drive\_k} )}^{2} \qquad ( 9 )$$

Accordingly, the amount of Peltier current (the amount of FF control) is calculated by calculating the sum of the drive current values corresponding to the N-number chips 201.

For example, in the simultaneous driving of the two chips 201, when a drive current of 100 mA is applied to one chip 201 and a drive current of 200 mA is applied to the other chip 201, a value resulting from addition of the amount of Peltier current when I_{drive}=100 mA to the amount of Peltier current when I_{drive}=200 mA is used as the amount of FF control based on the table in FIG. 15.

As described above, even when the optical module 200 is configured as an N-array element, it is possible to control one Peltier TEC 205 to increase the speed of the temperature control of each chip 201.

Examples of a temperature control method and the operation of an optical device according to a second modification will now be described.

First, for example, during the shipping test of the optical device, the current controller 106 acquires the measurement values illustrated in FIGS. 14 and 15 for one of the N-number chips 201. When the N-number chips 201 are linearly arranged, the chip 201 near the center of the arrangement may be used as the target of the measurement. This allows a variation in characteristics during the manufacture of the chips 201 to be averaged. Then, the thermal time constant t1 of the optical module 200 is acquired by, for example, the method described above with reference to FIG. 4. In addition to the thermal time constant t1, the thermal time constants t2 and t3 may be acquired. Also in this case, when the N-number chips 201 are linearly arranged, the chip 201 near the center of the arrangement may be used as the target of the measurement in consideration of a variation in characteristics during the manufacture of the chips 201.

Then, for example, during the operation of the optical device, the current controller 106 calculates the amounts of drive current (I_{drive}_{_{—}}₁ to I_{drive}_{_{—}}_{N}) of the chips 201, used to keep a substantially constant output level, based on information (the variation in the input signal and wavelength control signals, etc.) about the input signal.

Then, the current controller 106 calculates a difference ΔT between the result of measurement of the ambient temperature by the temperature sensor 11 and the result of measurement (the desired temperature) of the chip temperature by the thermistor 202 to calculate the amount of Peltier current I_{TEC} corresponding to the calculated difference ΔT based on the result of measurement illustrated in FIG. 14.

Then, the current controller 106 calculates amounts of Peltier current I_{TEC}_{_{—}}₁ to I_{TEC}_{_{—}}_{N} corresponding to the calculated amounts of drive current I_{drive}_{_{—}}₁ to I_{drive}_{_{—}}_{N} based on the result of measurement illustrated in FIG. 15 to calculate the sum of the amounts of Peltier current I_{TEC}_{_{—}}₁ to I_{TEC}_{_{—}}_{N}.

Then, the current controller 106 adds the calculated sum of the amounts of Peltier current I_{TEC}_{_{—}}₁ to I_{TEC}_{_{—}}_{N} to the amount of Peltier current I_{TEC} to calculate the amount of FF control and applies the amount of FF control to the Peltier TEC 205 the thermal time constant t1 before the input of the input signal into the chip 201.

Then, the current controller 106 applies the calculated amounts of drive current I_{drive}_{_{—}}₁ to I_{drive}_{_{—}}_{N} to the respective chips 201 the thermal time constant t1 after the application of the amount of Peltier current corresponding to the amount of FF control to the Peltier TEC 205, that is, at the time when the input signal is input into the chips 201.

As described above, according to the second modification, since the feedforward temperature control is performed with one Peltier TEC 205 even when the optical module 200 is configured as an N-array element, it is possible to increase the speed of the temperature control of each chip 201. In addition, since there is no need to provide the Peltier TEC 205 for every chip 201, it is possible to reduce the size of the optical device.

### [4] Others

The configuration and process of each of the optical module 200, the optical device 300, and the optical device 300′ may be selectively adopted according to need or may be appropriately combined.

The input signal light may be a burst signal or periodic signal light.

It is possible to increase the speed of the temperature control of the optical element.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A temperature control method in an optical device including an optical element that is driven in response to a drive current that is applied thereto, a temperature controller that changes a temperature of the optical element, and a controller that controls a current to the temperature controller, the temperature control method comprising:
determining, by the controller, a time from when an amount of heat from the temperature controller has been generated by the current control until the amount of heat reaches the optical element; and
controlling, by the controller, the current to the temperature controller the determined time before the drive current starts to flow through the optical element.

2. The temperature control method according to claim 1, further comprising:
measuring an environmental temperature around the optical element by a first temperature sensor provided around the optical element;
measuring, by the controller, a temperature difference between a desired temperature of the optical element and the environmental temperature; and
determining, by the controller, an amount of control current to be supplied to the temperature controller based on the drive current and the temperature difference.

3. The temperature control method according to claim 2, further comprising:
changing the desired temperature in a state in which the drive current is not applied to the optical element to measure a first amount of control current for setting the temperature of the optical element to the desired temperature subjected to the change by the controller;
changing the drive current in a state in which the desired temperature substantially equals to the environmental temperature to measure a second amount of control current for setting the temperature of the optical element to the desired temperature by the controller; and
determining the amount of control current to be supplied to the temperature controller based on the first amount of control current and the second amount of control current by the controller.

4. The temperature control method according to claim 1, further comprising:
performing feedback control to the amount of control current based on a result of measurement in a second temperature sensor that measures the temperature of the optical element by the controller.

5. The temperature control method according to claim 1,
wherein an optical signal input into the optical device is a wavelength multiplexing signal.

6. The temperature control method according to claim 1,
wherein an optical signal input into the optical device is a burst signal.

7. A temperature control apparatus controlling a temperature of an optical element that is driven in response to a drive current that is applied, the temperature control apparatus comprising:
a temperature controller that changes the temperature of the optical element; and
a controller that controls current to the temperature controller,
wherein the controller determines a time from when an amount of heat from the temperature controller has been generated by the current control under the controller until the amount of heat reaches the optical element and controls the current to the temperature controller the determined time before the drive current is applied to the optical element.

8. The temperature control apparatus according to claim 7, further comprising:
a first temperature sensor provided around the optical element,
wherein the first temperature sensor measures an environmental temperature around the optical element, and
wherein the controller measures a temperature difference between a desired temperature of the optical element and the environmental temperature and determines an amount of control current to be supplied to the temperature controller based on the drive current and the temperature difference.

9. The temperature control apparatus according to claim 8,
wherein the controller changes the desired temperature in a state in which the drive current is not applied to the optical element to measure a first amount of control current for setting the temperature of the optical element to the desired temperature subjected to the change, changes the drive current in a state in which the desired temperature substantially equals to the environmental temperature to measure a second amount of control current for setting the temperature of the optical element to the desired temperature, and determines the amount of control current to be supplied to the temperature controller based on the first amount of control current and the second amount of control current.

10. The temperature control apparatus according to claim 7, further comprising:
a second temperature sensor that measures the temperature of the optical element,
wherein the controller performs feedback control to the amount of control current based on a result of measurement in the second temperature sensor.

11. The temperature control apparatus according to claim 7,
wherein a plurality of optical elements are provided, and
wherein optical signals input into the plurality of optical elements are wavelength multiplexing signals.

12. The temperature control apparatus according to claim 7,
wherein an optical signal input into the optical element is a burst signal.

13. An optical device comprising:
an optical element that is driven in response to a drive current that is applied;
a temperature controller that changes the temperature of the optical element; and
a controller that controls current to the temperature controller,
wherein the controller determines a time from when an amount of heat from the temperature controller has been generated by the current control under the controller until the amount of heat reaches the optical element and controls the current to the temperature controller the determined time before the drive current is applied to the optical element.
